(19) United States
(12) Patent Application Publication
(10) Pub. No.: US 2023/0196405 A1
(43) Pub. Date: Jun. 22, 2023

(54) ELECTRONIC MARKETING SYSTEM AND ELECTRONIC MARKETING METHOD

(71) Applicant: Awoo Intelligence, Inc., Taipei City (TW)

(72) Inventors: Szu Wu Lin, Taipei City (TW); Kuo Ming Lin, Taipei City (TW); Chen Wei Lee, Taipei City (TW)

(21) Appl. No.: 17/751,379

(22) Filed: May 23, 2022

(30) Foreign Application Priority Data
Dec. 22, 2021 (TW) 110148299

(51) Int. Cl. G06Q 30/02

(52) U.S. Cl. CPC G06Q 30/0251

(57) ABSTRACT

An electronic marketing system and an electronic marketing method, wherein, by retrieving the user's browsing traces, browsing history and other de-identified information on the website or the Internet, the similar users can be still effectively grouped without using the user's personal information. The product can be matched with the user to filter out the candidate products that the user may purchase. Alternatively, the product to be sold can be selected first to conduct the matching process, thereby creating a candidate user group. Thereafter, the product leaflet can be generated from candidate products and sent to each user in the candidate user group. Moreover, the user information can be adjusted in real time after the user clicks on the product leaflet. The targeted marketing can still be achieved without use of personal information. Furthermore, the user information can be adjusted in real time to achieve the optimal electronic marketing effect.

### BACKGROUND OF INVENTION

### (1) Field of the Present Disclosure

The present disclosure is applied to e-marketing (Internet Marketing and Online Marketing), and particularly refers to a method that uses artificial intelligence to match products with vectorized user path data so as to screen out candidate products and candidate user groups. Meanwhile, product leaflets are created according to the candidate products and sent to each user in the candidate user group.

(2) Brief Description of Related Art

With the development of big data technology, targeted marketing has been widely applied in various fields. In particularly, the field of email marketing has grown significantly. The related prior art includes:

(1) “Personalized Advertising System” (TWI644273B): The location tracking technology is employed to detect users' activities in the store, thereby determines through preference learning the products, delivery methods and discounts of the advertisements to be pushed;

(2) “Method for predicting product click-through rate based on deep learning” (CN110555719A);

(3) “Directed trajectories through communication decision tree using iterative artificial intelligence” (US20190102681A1);

(4) “Advertising distribution device and its program” (JPA2018160071)

(5) “Direct mail management system and direct mail management method” (JPB006791346)

Although the technical means disclosed in the prior art can achieve the purpose of precise marketing, the disclosed technical means still need to analyze the user's personal information, such as location, gender, age, income, educational experience, etc., to determine the products to be promoted. Due to the growing awareness of protecting personal information, such practices may violate personal privacy. In addition, only through the analysis of personal information, it is difficult to keep pace with the times, truly meet the needs of users, and launch products that users are interested in and need. Furthermore, the conventional way to recommend products can only achieve the promotion of products with a high degree of homogeneity. Therefore, it is difficult to effectively expand the transaction volume of candidate products. Accordingly, how to achieve targeted marketing without using personal information, how to change the products recommended to users at any time, and how to expand the scope of recommended products, are urgent problems to be solved.

### SUMMARY OF INVENTION

It is a primary object of the present disclosure to provide an electronic marketing system and an electronic marketing method through which the user's web browsing history is used to further group the users and recommend suitable products to the users, thereby achieving the effect of targeted marketing.

According to the present disclosure, an electronic marketing system includes an artificial intelligence module, which is used to first retrieving the user's browsing path and history on the Internet as user path data. The user path data are vectorized and calculated to form a user feature vector matrix, which is used as user information. In addition, the artificial intelligence module further matches the user information with the product information with product label based on a string network to filter out candidate products and candidate user groups that can be matched with each other. Also, the artificial intelligence module can select multiple users with similar information as user groups and multiple products with associated product labels as product groups. The user group and the product group can be used as the optional parameters of the candidate user group and the candidate product. Furthermore, the electronic marketing system generates a product leaflet for the candidate product. The product leaflet records each candidate product and includes a URL link. Then, the product leaflet is sent to the user information device of each user in the candidate user group. Moreover, after the user clicks on the URL link of the product leaflet, a feedback message can be sent back to the electronic marketing system through the URL link. The electronic marketing system can modify the product content of the product leaflet issued each time accordingly, thereby achieving the targeted marketing effect without the use of personal information. In this way, the products recommended to the users can be adjusted at any time. In addition, the scope of the recommended products can be further expanded.

### BRIEF DESCRIPTION OF THE DRAWINGS

FIG. 1 is a block diagram of a system according to the present disclosure;

FIG. 2 is a flow chart of a method according to the present disclosure;

FIG. 3 is an implementation view I of the present disclosure;

FIG. 4 is an implementation view II of the present disclosure;

FIG. 5 is an implementation view III of the present disclosure;

FIG. 6 is an implementation view IV of the present disclosure;

FIG. 7 is an implementation view V of the present disclosure;

FIG. 8 is an implementation view VI of the present disclosure; and

FIG. 9 is an implementation view VII of the present disclosure.

### DETAILED DESCRIPTION OF PREFERRED EMBODIMENTS

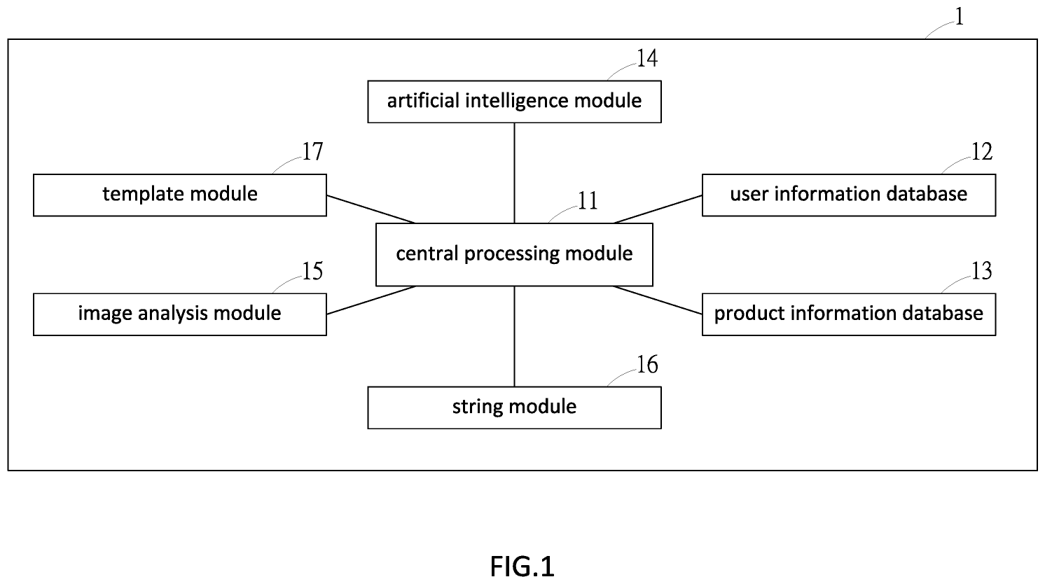

Referring to FIG. 1, the electronic marketing system 1 sends the product leaflet to a user information device 2. The electronic marketing system 1 includes a central processing module 11. A user information database 12, a product information database 13, an artificial intelligence module 14, an image analysis module 15, a string module 16, and a template module 17 are in informational connection with the central processing module 11 respectively. The function of the above-mentioned components are detailed as follows:

The data processing unit 10 is used to drive the user information database 12, the product information database 13, the artificial intelligence module 14, the image analysis module 15, the string module 16, and the template module 17. The central processing module 11 has functions such as logical operation, temporary storage of operation results, and storage of execution instruction positions. The data central processing module 11 can be a central processing unit (CPU). It is understood that the invention is not limited thereto.

The user information database 12 stores at least one user information representing each user. The user information includes path data of each user retrieved by the artificial intelligence module 14. The user path data is vectorized and formed into a user feature vector matrix, which represents the “user features” of each user. The user path data is the data retrieved from users on the website or the network, such as the browsing traces, the browsing path, the browsing history, the triggered events, the clicks, the behaviour operations, the website stay time, or a combination thereof. The user path data are any data that can be left behind through traces on the Internet and are not personal data. The user information also includes a user label, which is extracted by the artificial intelligence module 14 based on the string network from “keywords”, “popular words”, “valuable words”, words/texts in the user path data, or a combination thereof. Optionally, the user information database 12 also stores at least one user group. The user group is created from the artificial intelligence module 14 by using the user feature vector matrix to group a plurality of similar user information. Meanwhile, the user information database 12 is stored in the memory.

The product information database 13 stores a plurality of product information with product labels, and is also used for receiving product information with the product labels assigned by the artificial intelligence module 14. Optionally, the product information database 13 stores at least one product group which is composed of a plurality of related product information grouped by the artificial intelligence module 14 based on the string network. Moreover, the product information database 13 is stored in the memory.

The artificial intelligence module 14 is used to retrieve the user path data of each user, thereby performing a first machine learning by use of the user path data serving as past data and a second machine learning by use of vector grouping learning data serving as past data. In this way, a model is constructed to vectorize the user path data into a user feature vector matrix. The user feature vector matrix is stored in the user information database 12 as user information. The user path data is the data retrieved from users on the website or the network, such as the browsing traces, the browsing path, the browsing process, the triggered events, the clicks, the behaviour operations, the website stay time, or a combination thereof. The user path data are any data that can be left behind through traces on the Internet and are not personal data. The first machine learning and the second machine learning are performed by use of supervised learning, semi-supervised learning, reinforcement learning, unsupervised learning, self-supervised learning, or heuristic algorithms. The artificial intelligence module 14 extracts a user label in the user path data based on the string network generated by the string module 16. The user label is extracted from “keywords”, “popular words”, “valuable words”, words/texts in the user path data, or a combination thereof. The user label can serve as user information. The artificial intelligence module 14 is also used to classify and assign a plurality of product labels to product images analyzed by the image analysis module 15. Preferably, the artificial intelligence module 14 cooperates with the string module 16 to assign the product label to the product image based on the string network, and store the product image with the product label in the product information database 13 as product information. The product label is formed by words, texts, or a combination thereof. The artificial intelligence module 14 matches the user information with the product information, and filters out at least one candidate user group that may have a purchase tendency for the product, or at least one candidate product that the user wants to purchase.

The image analysis module 15 divides the image in the product information, and recognizes the text in the product image, so as to cooperate with the artificial intelligence module 14 to assign a plurality of product labels/texts to the product image.

The string module 16 collects the text, and extracts valuable words or words in the text by machine learning. The valuable words or words are popular words with high search frequency and topicality. Meanwhile, the interrelated words can be concatenated to form a string network and stored.

The template module 17 stores a plurality of leaflet templates so that the artificial intelligence module 14 can screen out the products to be promoted, perform the layout modification, and create a product leaflet. Each product image in the product leaflet has a URL link for the user to quickly link to the purchase page. When the user clicks this URL link, a feedback message will be sent back to the electronic marketing system 1 for the artificial intelligence module 14 to change the user feature vector matrix of the user information, modify the matching between the product and the user, and further adjust the content of the product leaflet. Optionally, the template module 17 performs template selection and automatic layout modification based on one or a combination of candidate user groups, candidate products, the degree of relevance and the weighting value between the candidate user groups and the candidate products, etc. The weighting value is set by the electronic marketing system 1 and is also determined by the electronic marketing system 1 based on the string network.

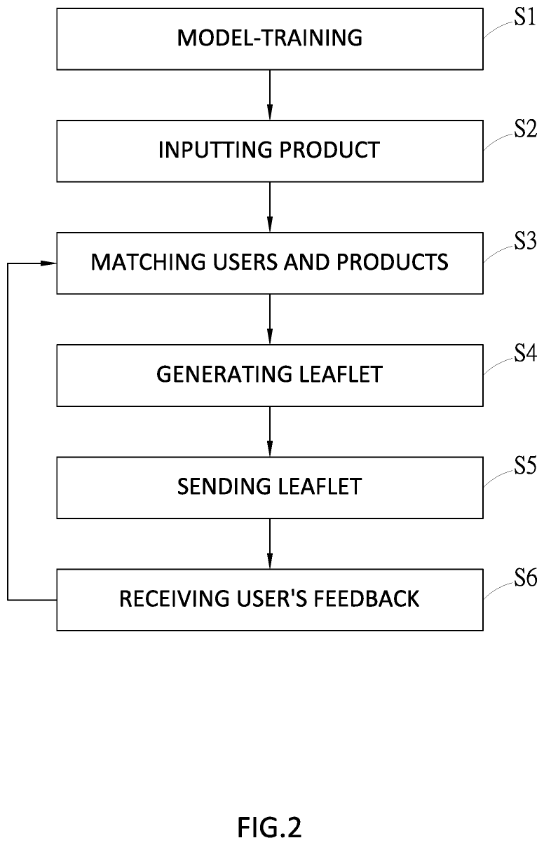

As shown in FIG. 2, a method of the present disclosure includes the following steps:

Step S1 of Model-training. The electronic marketing system 1 uses user a path data as past data to perform a first machine learning and uses a vector grouping learning data as past data to perform a second machine learning to construct a model. The first machine learning and the second machine learning includes one of supervised learning, semi-supervised learning, reinforcement learning, unsupervised learning, self-supervised learning, or heuristic algorithms.

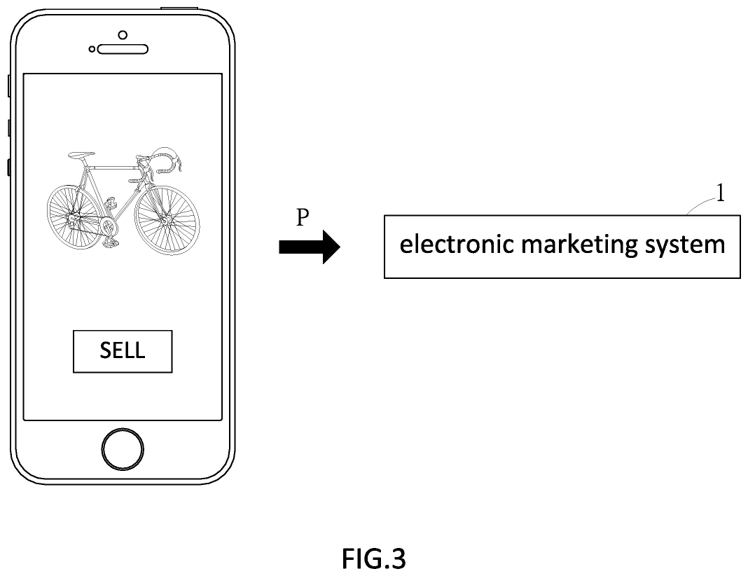

Step S2: Inputting product. As shown in FIG. 3, the electronic marketing system 1 receives a product information P to be sold. The product information P includes the name, the material, the classification, the use, the function, the picture, etc. of the product. The electronic marketing system 1 analyzes the product information P. Based on the string network, the electronic marketing system 1 classifies the product information P into groups and assigns a plurality of product labels thereto. After the product information P is analyzed and assigned with the product label, the product information P is stored in the product information database 13. As shown in FIG. 3, when the product to be sold is a bicycle, the electronic marketing system 1 receives the image of the bicycle. After the image is analyzed, grouped, assigned with the product labels “bicycle”, “racing”, “scooter”, and the text description “carbon fiber lightweight”, they are stored in the product information database 13.

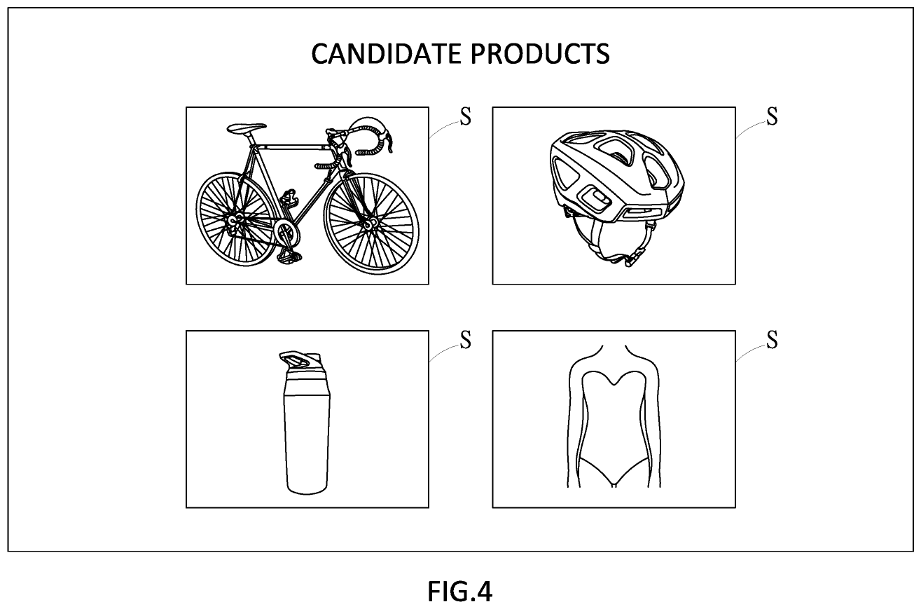

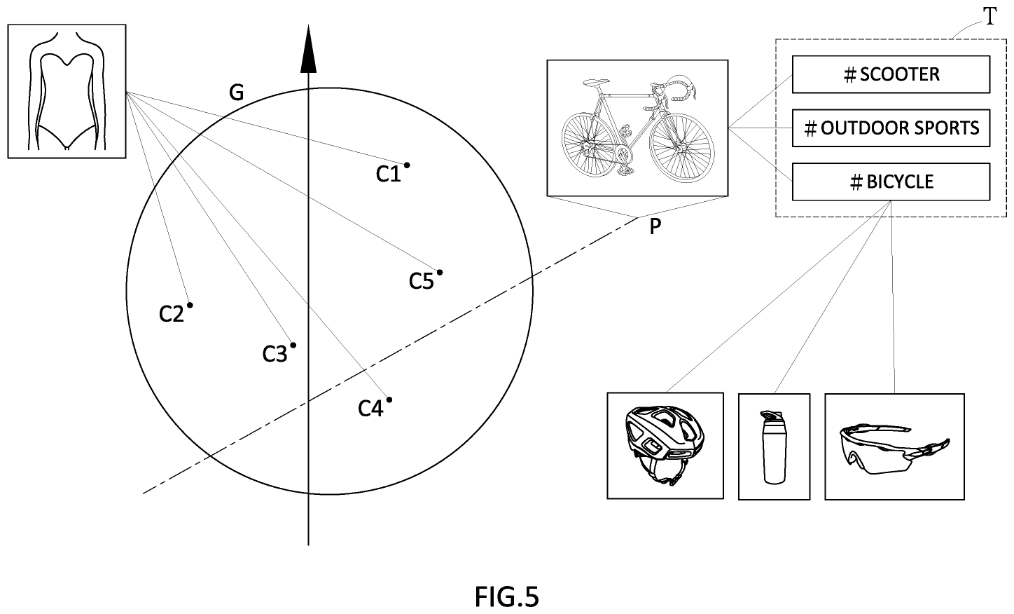

Step S3: Matching users and products. Referring to FIG. 4 and FIG. 5, in carrying out electronic marketing, at least one product information P or product group stored in the product information database 13 is selected as a candidate product S to be sold. Based on the string network, the electronic marketing system 1 matches the candidate product information P or the candidate product group with the user information stored in the user information database 12 and the product information P or the product group and filters out at least one candidate user group composed of candidate users with high purchase probability or potential consumers. The candidate user group is further vectorized by the electronic marketing system 1 based on a model to form a user feature vector matrix, and each user that is similar to the user feature vector matrix of the candidate user is added to the candidate user group. Based on the string network, the electronic marketing system 1 further filters out another related candidate product group and candidate user group as candidates from the selected candidate product S and candidate user group. In addition, at least one user or a user group stored in the user information database 12 is also selected as a candidate and used as the target to be promoted. The electronic marketing system 1 matches one or more candidate user groups with the candidate product information P or product group stored in the product information database 13, and filters out at least one candidate product S or potential candidate product group with high purchase probability. Based on the string network, the electronic marketing system 1 further filters out another related product group and another candidate user group as candidates from the selected candidate user group and candidate product. As shown in FIG. 4 and FIG. 5, “bicycle” is selected as the product to be sold. The electronic marketing system 1 matches the “bicycle” with the user information, and selects at least one candidate user C1 or a candidate user group G which has a high purchase probability or potential consumers. The candidate user group G includes users (C1˜C5), and further selects the “water bottle” associated therewith as the candidate product S. In addition to the feature associated with “bicycle”, the candidate user group G has some other candidate users (C1˜C5) with the feature of “swimming”, so the electronic marketing system 1 takes “swimsuit” as a candidate product.

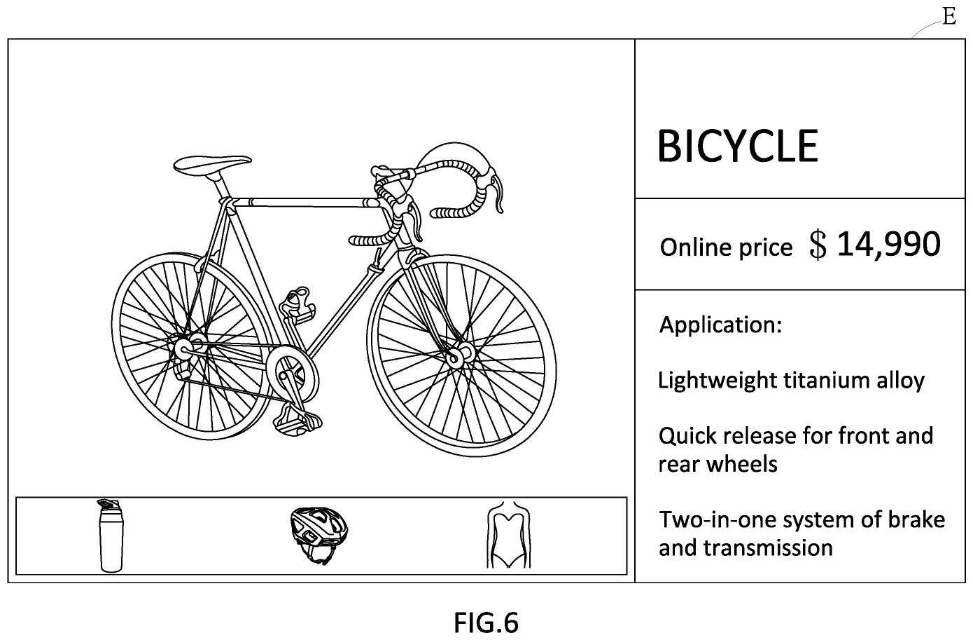

Step S4 of generating leaflet. Referring to FIG. 6, the electronic marketing system 1 generates a product leaflet E after determining the candidate product. Optionally, based on candidate users, candidate products, the degree of correlation between each product and candidate users, weighting value, etc., template selection is performed the automatic layout modification of the product images. For example, since the selected candidate product is a bicycle, and the optimal candidate products selected by the system are “water bottle”, “safety helmet”, etc., the electronic marketing system 1 uses a specific template to highlight the “bicycle” with high weighting value. Moreover, the product image has a URL link for users to quickly link to the purchase page. The above example is only an example. It is understood that the invention is not limited thereto.

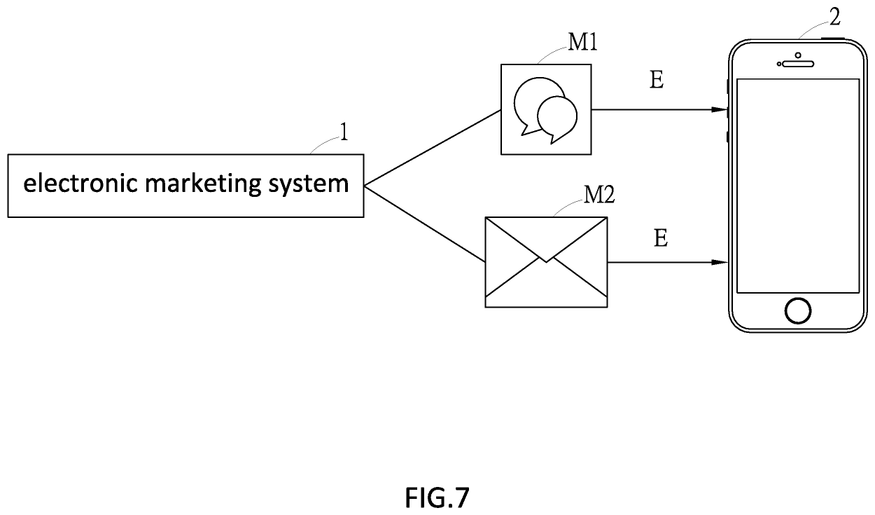

Step S5 of sending leaflet: Referring to FIG. 7, the electronic marketing system 1 sends the product leaflet E to each selected, matched, and candidate users or user groups. The sending way is selected from a group consisting of Instant Messaging, Electronic Mail, and SMS (short message service). As shown in FIG. 7, the electronic marketing system 1 sends the product leaflet E related to the “bicycle” to the user information device 2 of each candidate user through instant messaging or email.

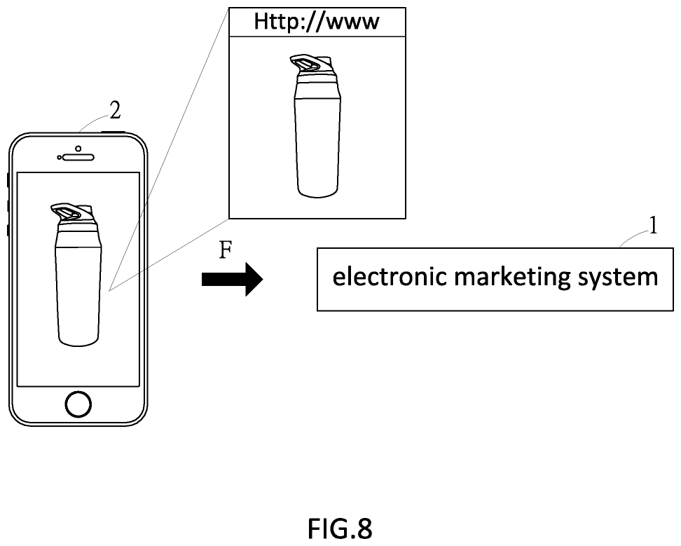

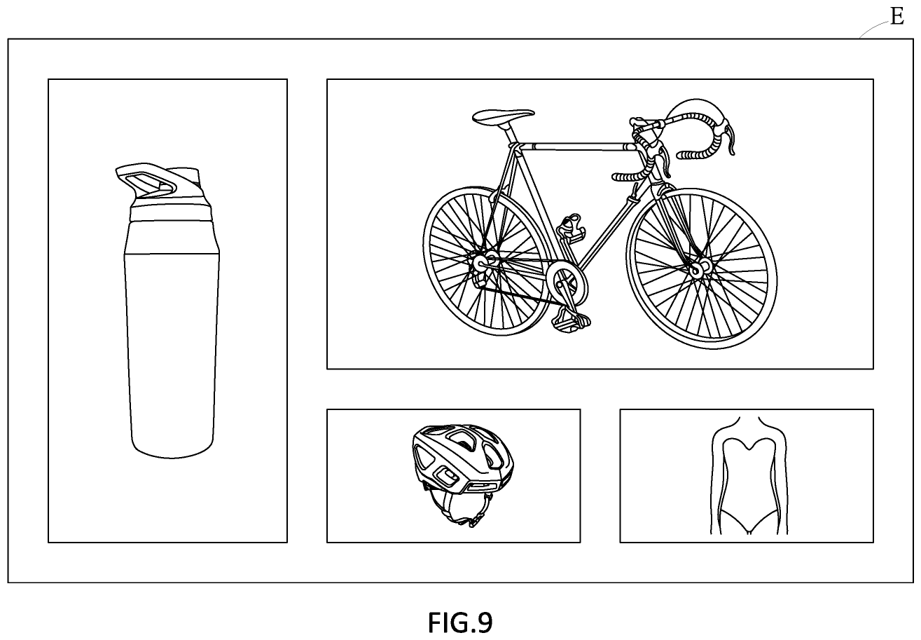

Step S6 of receiving user's feedback S6: Referring to FIG. 8 and FIG. 9, the product leaflet E has a URL link. When the user clicks on the product of the product leaflet E, the electronic marketing system 1 receives a feedback message F. The electronic marketing system 1 will modify the user information based on the feedback message F, and change the candidate products and their weighting value and degree of relevance accordingly, and further adjust the layout of the next product leaflet E. For example in FIG. 8 and FIG. 9, after the user information device receives the product leaflet E of “bicycle”, a click on “water bottle” is done such that the electronic marketing system 1 will receive the feedback message F. Thereafter, the electronic marketing system 1 modifies the user information based on the feedback message F. Meanwhile, the electronic marketing system 1 further modifies the layout and content of the product leaflet E based on the modified user information. Referring to FIG. 9, the product leaflet E has “water bottle” occupying a larger layout, so that the “bicycle” originally occupying a large layout will reduce the layout proportion, and replace the “swimsuit” product with a bottle holder, so that the product leaflet E can achieve a more accurate marketing effect.

According to the present disclosure, the electronic marketing system includes the central processing module, the user information database, the product information database, the artificial intelligence module, the image analysis module, the string module, and the template module. Through the cooperation between various modules, the products are quickly labeled and matched with the users after the feature vectorization, so as to filter out the most suitable candidate products and users. Meanwhile, the product leaflet can be adjusted according to weighting value and degree of relevance, and sent out via instant messaging, email, SMS, etc. When the user who receives the product leaflet operates it, a feedback message can be sent back to the electronic marketing system. Based on the feedback message, the electronic marketing system can further modify the user information, the candidate products and their weighting value and degree of relevance, and adjust the layout of the next product leaflet. Accordingly, users can be quickly grouped by using the user feature vector matrix. Meanwhile, the string network is employed to achieve the targeted marketing without the use of personal information. Moreover, the products recommended to users can be adjusted at any time, and the effect of the recommended product category can be expanded.

### REFERENCE SIGN

1 electronic marketing system
11 central processing module
12 user information database
13 product information database
14 artificial intelligence module
15 image analysis module
16 string module
17 template module
2 user information device
S1 model-training
S2 inputting product
S3 matching users and products
S4 generating leaflet
S5 sending leaflet
S6 receiving user's feedback
P product information
T product label
E product leaflet
S candidate product
C1˜C5 user
G user group
F feedback message
M1 instant messaging
M2 e-mail

What is claimed is:

1. An electronic marketing system for generating a product leaflet for the purpose of targeted marketing, comprising:
a central processing module configured to run the electronic marketing system, a user information database storing a plurality of user information, a product information database storing a plurality of product information, and a string module forming a string network, wherein the user information database, the product information database, and the string module are respectively in informational connection with the central processing module; and
an artificial intelligence module being in informational connection with the central processing module, wherein, based on a model, a user path data is vectorized to form a user feature vector matrix, and the artificial intelligence module further extracts a user label from the user path data based on the string network, and a user information is generated by combining the user feature vector matrix and the user label;
wherein the artificial intelligence module then matches the user information with a plurality of product information based on the string network, and filters out a candidate user group composed of at least one candidate user or at least one candidate product, and the artificial intelligence module generates the product leaflet based on the candidate product.

2. The electronic marketing system as claimed in claim 1, wherein the artificial intelligence module is used to perform a first machine learning on the user path data and a second machine learning on a vector grouping learning data to construct the model.

3. The electronic marketing system as claimed in claim 1, wherein the user path data is one or a combination of browsing traces, browsing path, browsing process, triggered events, clicks, behaviour operations, or website stay time on the website or the network.

4. The electronic marketing system as claimed in claim 1, wherein an image analysis module is connected to the central processing module for analyzing a product image, and the artificial intelligence module assigns a product label to the analyzed product image to form the product information.

5. The electronic marketing system as claimed in claim 1, wherein a template module is informationally connected to the central processing module for conducting layout changes to the product leaflet.

6. The electronic marketing system as claimed in claim 5, wherein the template module performs layout changes based on one or a combination of the user information, the product information, a degree of relevance between the candidate user and the candidate product, and the weighting value.

7. The electronic marketing system as claimed in claim 1, wherein the candidate product is a product group composed of a plurality of related product information.

8. The electronic marketing system as claimed in claim 1, wherein the electronic marketing system sends the product leaflet to each candidate user via one or a combination of an instant messaging software, an email, or a SMS.

9. The electronic marketing system as claimed in claim 8, wherein each product information of the product leaflet has a URL link, and when a click on the URL link is done through the user information device, the electronic marketing system receives a feedback message and modifies the user information.

10. The electronic marketing system as claimed in claim 9, wherein the electronic marketing system re-matches the modified user information with the product information to generate another product leaflet.

11. An electronic marketing method for generating a product leaflet for the purpose of targeted marketing, comprising steps of:
matching users and products, wherein an electronic marketing system matches a product with at least one product label with at least one user information, and filters out at least one candidate product and a candidate user group composed of at least one candidate user, and wherein the user information includes a user feature vector matrix formed by vectorizing a user path data based on a model and a user label extracted by the electronic marketing system based on a string module from the user path data, and wherein the candidate user group is composed of a plurality of candidate users with similar user information;
generating leaflet, wherein the electronic marketing system generates the product leaflet based on the candidate product; and
sending leaflet, wherein the electronic marketing system sends the product leaflet to a user information device of each candidate user via one or a combination of an instant messaging software, an email, or a SMS.

12. The electronic marketing method as claimed in claim 11, further comprising a step of model training before the step of matching users and products, wherein the electronic marketing system performs a first machine learning on the user path data and a second machine learning on a vector grouping learning data to construct the model.

13. The electronic marketing method as claimed in claim 11, further comprising a step of receiving user's feedback after the step of sending leaflet, wherein the user information device performs the user feedback and generates a feedback message, and wherein after receiving the feedback message, the electronic marketing system modifies the user information based on the feedback message.

14. The electronic marketing method as claimed in claim 13, wherein the electronic marketing system re-matches the modified user information with the product information to generate another product leaflet.
